(19) United States
(12) Patent Application Publication
(10) Pub. No.: US 2021/0097058 A1
(43) Pub. Date: Apr. 1, 2021

(54) AIRCRAFT FAULT TROUBLESHOOTING SYSTEM USING SUPPLEMENTED AIRCRAFT MAINTENANCE LOG DATA

(71) Applicant: SparkCognition, Inc., Austin, TX (US)

(72) Inventors: Erik Skiles, Manor, TX (US); Joshua Bronson, Austin, TX (US); Mark Goddard, Austin, TX (US)

(21) Appl. No.: 16/584,512

(22) Filed: Sep. 26, 2019

(51) Int. Cl. G06F 16/23; G06F 16/28; G06N 20/00; G06N 5/04; B64F 5/40; G07C 5/08

(52) U.S. Cl. CPC G06F 16/2379; G06F 16/285; G07C 5/085; G06N 5/04; B64F 5/40; G06N 20/00

(57) ABSTRACT

A method includes accessing aircraft maintenance log data including maintenance entries associated with a plurality of aircraft. Each of the maintenance entries describes a respective maintenance task performed on a respective aircraft of the plurality of aircraft. The method also includes providing the maintenance entries as input to a trained classifier. In response to input of a maintenance entry, the trained classifier outputs a task identifier for the maintenance entry based on one or more fields of the maintenance entry. The method further includes determining task type labels for the maintenance entries. A task type label for a particular maintenance entry is determined based on the task identifier for the particular maintenance entry, and the task type labels indicate whether a respective maintenance entry describes a substantive task. The method also includes storing supplemental log data including the task identifiers and the task type labels.

### BACKGROUND

To facilitate troubleshooting, many aircraft include on-board health monitoring systems that report faults using fault codes. A particular fault code identifies a condition that occurred, but does not necessarily indicate the cause of the condition. For example, several distinct root causes can each lead to the production of a particular fault code.

A fault isolation manual for an aircraft describes a set of steps that can be used to isolate the cause of a fault. For example, each fault code can be associated with a specific fault isolation flow including a set of tasks to be performed to isolate the specific cause or causes of a particular fault. Even using the fault isolation manual, it can take significant time and resources to isolate some faults. To illustrate, a maintenance technician may have to perform several steps, such as several function checks, cycling power to certain subsystem, or replacing line-replaceable units (LRUs) in order to isolate the cause of the fault. Experienced maintenance technicians may skip around in the fault isolation flow, e.g., trying some steps that are later in the fault isolation flow before trying some earlier steps, based on prior experience. However, less experienced maintenance technicians are left to follow the step-by-step process of the fault isolation flow, which may not be optimally arranged to reduce time and resources required to isolate and correct the fault.

### SUMMARY

In a particular aspect, a system includes one or more processors and one or more memory devices storing instructions executable by the one or more processors to perform operations. The operations include accessing aircraft maintenance log data including maintenance entries associated with a plurality of aircraft. Each of the maintenance entries describes a respective maintenance task performed on a respective aircraft of the plurality of aircraft. The operations also include providing the maintenance entries as input to a trained classifier. In response to input of a maintenance entry, the trained classifier outputs a task identifier for the maintenance entry based on one or more fields of the maintenance entry. The operations further include determining task type labels for the maintenance entries. A task type label for a particular maintenance entry is determined based on the task identifier for the particular maintenance entry, and the task type labels indicate whether a respective maintenance entry describes a substantive task. The operations also include storing, in the one or more memory devices, supplemental log data including the task identifiers and the task type labels.

In another particular aspect, a method includes accessing aircraft maintenance log data including maintenance entries associated with a plurality of aircraft. Each of the maintenance entries describes a respective maintenance task performed on a respective aircraft of the plurality of aircraft. The method also includes providing the maintenance entries as input to a trained classifier. In response to input of a maintenance entry, the trained classifier outputs a task identifier for the maintenance entry based on one or more fields of the maintenance entry. The method further includes determining task type labels for the maintenance entries. A task type label for a particular maintenance entry is determined based on the task identifier for the particular maintenance entry, and the task type labels indicate whether a respective maintenance entry describes a substantive task. The method also includes storing supplemental log data including the task identifiers and the task type labels.

In another particular aspect, a computer-readable storage device stores instructions that are executable by a processor to perform operations. The operations include accessing aircraft maintenance log data including maintenance entries associated with a plurality of aircraft. Each of the maintenance entries describes a respective maintenance task performed on a respective aircraft of the plurality of aircraft. The operations also include providing the maintenance entries as input to a trained classifier. In response to input of a maintenance entry, the trained classifier outputs a task identifier for the maintenance entry based on one or more fields of the maintenance entry. The operations further include determining task type labels for the maintenance entries. A task type label for a particular maintenance entry is determined based on the task identifier for the particular maintenance entry, and the task type labels indicate whether a respective maintenance entry describes a substantive task. The operations also include storing, in the one or more memory devices, supplemental log data including the task identifiers and the task type labels.

### BRIEF DESCRIPTION OF THE DRAWINGS

FIG. 1 illustrates a particular example of a system that is operable to generate supplemental aircraft maintenance log data and to generate an ordered list of corrected tasks based on a search query.

FIG. 2 illustrates a particular example of a maintenance technician graphical interface including a work queue.

FIG. 3 illustrates a particular example of a maintenance technician graphical interface including a list of corrective tasks and technical manual information associated with a particular corrective task of the list of corrective tasks.

FIG. 4 illustrates a particular example of a maintenance technician graphical interface including a list of corrective tasks and annotated maintenance log entries associated with a particular corrective task of the list of corrective tasks.

FIG. 5 illustrates a flow chart of a particular example of a method of generating supplement aircraft maintenance log data and generating an ordered list of corrected tasks based on a search query.

FIG. 6 illustrates a particular example of a computer system including hardware and software configured to generate supplemental aircraft maintenance log data and to generate an ordered list of corrected tasks based on a search query.

### DETAILED DESCRIPTION

Particular implementations disclosed herein use natural language processing of aircraft maintenance logs to assist maintenance personnel with identifying solutions to specific faults or other aircraft maintenance issues. Additionally, by linking the suggested solutions to related maintenance log entries and technical manuals, the disclosed implementations provide supporting evidence to explain how the suggested solutions where identified.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. For ease of reference herein, such features are generally introduced as “one or more” features, and are subsequently referred to in the singular unless aspects related to multiple of the features are being described.

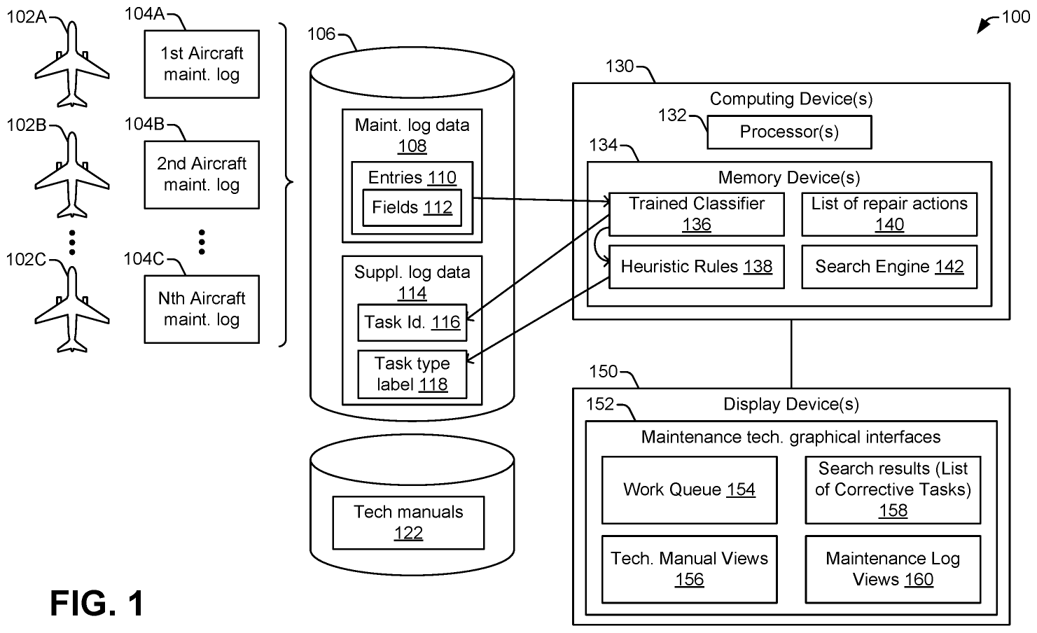

In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple the aircraft are illustrated and associated with reference numbers 102A, 102B, etc. When referring to a particular one of these aircraft, such as the aircraft 102A, the distinguishing letter “A” is used. However, when referring to any arbitrary one of these aircraft or to these aircraft as a group, the reference number 102 is used without a distinguishing letter.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 illustrates a particular example of a system 100 that is operable to generate supplemental aircraft maintenance log data and to generate an ordered list of corrected tasks based on a search query. The system 100 includes one or more computing devices 130 including, coupled to, or having access to a database 106 including aircraft maintenance log data 108.

The aircraft maintenance log data 108 is based on or includes a plurality of aircraft maintenance logs 104 for a corresponding plurality of aircraft 102. Each aircraft maintenance log 104 includes a record of maintenance activity for the corresponding aircraft 102. Although FIG. 1 illustrates the maintenance log data 108 as a single block, in some implementations, the database 106 can include a relational database or another data structure that include multiple interrelated tables or other data substructures. Also, although FIG. 1 illustrates the maintenance logs 104 as distinct from the maintenance log data 108, in some implementations, data associated with the maintenance logs 104 are aggregated in the maintenance log data 108 and the individual maintenance logs 104 can be extracted (e.g., via structured reports or queries) from the maintenance log data 108. For example, the individual aircraft maintenance logs 104 can exist within the maintenance log data 108 as distinct tables or data substructures.

The aircraft maintenance log data 108 includes a plurality of maintenance entries 110.

Each of the maintenance entries 110 describes a reported complaint or a maintenance task performed on a respective aircraft 102 of the plurality of aircraft 102. Each maintenance entry 110 includes or is divided into a plurality of fields 112, with each field 112 storing a corresponding type of data. To illustrate, a particular entry 110 can include fields 112 for an aircraft identifier (e.g., a tail number), an aircraft type, a maintenance activity performed, a complaint reported (e.g., a fault code, a gripe, or both), etc. Some of the fields 112 store natural language text, such as descriptors of tasks performed, descriptors of test results, or text associated with a fault code. Other fields store structured alphanumeric data such as fault code, aircraft tail numbers, or aircraft type descriptors. Still other fields 112 may store time and/or date stamps, or other types of data (e.g., labels or tags).

The computing device(s) 130 are configured to supplement the maintenance log data 108 and to provide user interface displays that assist maintenance technicians with maintaining (especially troubleshooting) an aircraft 102, as described further below. The computing device(s) 130 include one or more processors 132 and one or more memory devices 134. The memory device(s) 134 store instructions that are executable by the processor(s) 132 to generate supplemental log data 114 and to generate one or more graphical interface displays, such as various maintenance technician graphical interfaces 152. In the example illustrated in FIG. 1, the instructions include a trained classifier 136, heuristic rules 138, and a search engine 142. In some implementations, the instructions include more, fewer, or different instructions. For example, the instructions can include one or more applications that facilitate entry of maintenance log data (e.g., to generate the entries 110).

The instructions are executable by the processor(s) 132 to access the aircraft maintenance log data 108 and to provide the maintenance entries 110 (or a subset of the maintenance entries 110) as input to the trained classifier 136. The trained classifier 136 is a machine learning model, such as a neural network, a decision tree, a support vector machine, etc., that is trained to assign a task identifier 116 to a maintenance entry 110 based on one or more fields 112 of the maintenance entry 110. The task identifier 116 corresponds to a task or procedure in a maintenance technical manual associated with the aircraft 102. Maintenance technical manuals for the aircraft 102 include step-by-step procedures for removal and replacement of LRUs and other components of the aircraft 102. Generally, each procedure is associated with an index value (such as an alphanumeric value indicating a volume, chapter, and page within a specific maintenance manual) to facilitate identification of the procedure and cross-referencing of the procedure within other procedures. In a particular implementation, a task identifier 116 assigned by the trained classifier 136 corresponds to the index value of a particular procedure in the maintenance technical manual. To illustrate, if removal of a flight control computer is described in the maintenance technical manual at a location associated with index value “43-12-273”, the task identifier 116 assigned by the trained classier 136 to a maintenance log entry 110 describing removal of the flight control computer of a particular aircraft 102 would be “43-12-273” or a value or text readily cross-referenced to the index value “43-12-273”.

Certain aircraft maintenance logs 104 may include a field to list the index value of a procedure performed. However, because aircraft technicians are often hurried and/or working from memory after performing maintenance, the aircraft technicians sometimes identify an incorrect or incomplete index value for the procedure performed. For example, several maintenance tasks may be performed and described in text description of a maintenance entry 110; however, all of these various operations may be associated with one general reference to a volume or chapter of a maintenance technical manual, rather than to the specific procedures performed. As another example, an aircraft technician may list an index value of a fault isolation procedure that instructs performance of a specific maintenance procedure. As a result, the fields 112 purporting to indicate the index value of performed procedures are not necessarily a reliable indicator of the actual maintenance procedures performed.

Aircraft technicians much more reliably record maintenance tasks performed in their text descriptors; however, these are often filled with jargon, abbreviations, and short-hand comments. To illustrate, “remove and replace” is often listed as “R&R” or “R2”.

The trained classifier 136 is trained to assign one or more task identifiers 116 to an entry 110 based on a combination of fields 112 of the entry 110 in order to more accurately reflect the specific procedure or procedures performed. In a particular implementation, the trained classifier 136 uses natural language processing techniques to evaluate a text field describing the maintenance tasks performed in order to assign the task identifier(s) 116. For example, each word of the text field can be converted to a vector (e.g., a wordvec) corresponding to a point in a feature space. The content of the text field can be parsed into individual clauses or phrases (e.g., based on the location of punctuation, conjunctions, or other indicators), and the vectors of each clause or phrase can be provided as input to a neural network with one or more recurrent layers (e.g., one or more long short term memory (LSTM) layers) to determine a task identifier 116 associated with the clause or phrase. In some implementations, additional information can be provided to the trained classifier 136 to generate the task identifier(s) 116. For example, one or more of the fields 112 for an entry 110 can include data indicating a fault code, a gripe (e.g., a free form or preconfigured text descriptor associated with a fault), an aircraft type, or other information that can also be used to assign the task identifier(s) 116. To illustrate, if the fault code indicates a problem with a specific LRU, and the text field merely indicates removal and replacement of an unspecified LRU, the trained classifier 136 can be trained such that the task identifier 116 assign is for removal and replacement of the LRU identified by the fault code.

The trained classifier 136 is initially trained (and may be subsequently updated or retrained) using supervised training data. For example, a collection of historical maintenance log data can be provided to a subject matter expert to assign a task identifier label to each entry (or at least a subset of the entries) of the historical maintenance log data. The supervised training data can then be used to generate (e.g., via an automated model building process) or train a classifier. As a specific example, the supervised training data can be provided as input to an automated model building process that uses neuroevolutionary processes to build a population of classifiers, and one of the classifiers of the population can be selected for use as the trained classifier. To illustrate, a most reliable or most efficient (in terms of processing resources or memory resources) classifier of the population can be selected. In another example, a population of classifiers can be automatically generated and/or trained, and two or more of the classifiers can be ensembled to form the trained classifier.

The task identifier(s) 116 assigned by the trained classifier 136 to an entry 110 is stored as supplemental log data 114. In some implementations, each task identifier 116 is appended to the corresponding entry 110 (e.g., the supplemental log data is incorporated within fields 112 of the maintenance log data). In other implementations, the supplemental log data 114 is stored separately from and cross-referenced to the maintenance log data 108. For example, a task identifier 116 assigned to a specific entry 110 can be stored in a data table or other data structure separate from the entry 110 but with a key or index identifying the entry 110. Since the maintenance log data 108 is stored in part for regulatory compliance, it may be desirable to store the supplemental log data 114 in a manner that does not modify the maintenance log data 108.

In a particular implementation, the instructions are also executable to provide the task identifier(s) assigned to one or more entries 110 as input to the heuristic rules 138 to assign task type labels 118. The task type labels 118 indicate whether each task is a substantive or a non-substantive task, and may also identify a corrective task.

During maintenance of an aircraft 102, many different procedures are typically performed. For purposes of the following description, these procedures are described as including substantive procedures and non-substantive procedures. As used herein, a procedure is a “substantive procedure” if the procedure is intended to or has the capacity to correct a fault (whether the procedure actually corrects the fault or not). For example, replacement of an LRU associated with a fault is a substantive procedure because replacing the LRU may clear the fault. Note, in this example that replacing the LRU is a substantive procedure even if replacing the LRU does not correct the fault. Substantive procedures can also be described as reparative procedures or repair actions in that they are procedure intended to or capable of effecting a repair. As used herein, a procedure is a “non-substantive procedure” if the procedure is not a substantive procedure, i.e., if the procedure is not intended to or des not have the capacity to correct a fault. For example, a function check or test may be part of a fault isolation procedure, but it is not intended to clear a fault and is therefore a non-substantive procedure, as used herein. Similarly, removing an aircraft skin panel to access an LRU may be part of a maintenance procedure, but unless the aircraft skin panel itself is damaged and to be replaced, removing the aircraft skin panel does not itself repair a fault. Non-substantive procedures can also be described as procedural actions.

In a particular implementation, the processor(s) executing the heuristic rules 138 compare each task identifier 116 to a list of repair actions 140 to determine whether each task or procedure is substantive. For example, the list of repair actions 140 may be prepared by a subject matter expert and may identify each task or procedure in a maintenance technical manual or fault isolation manual that is substantive. In some implementations, the list of repair actions 140 may also include context information to differentiate one or more first contexts in which a particular procedure is substantive and one or more second contexts in which the particular procedure is non-substantive. For example, the context information can include an aircraft type identifier, a fault code, a gripe, other information, or a combination thereof. To illustrate, if the fault code or gripe associated with maintenance activity relates to damage to an aircraft skin panel, then removing and replacing the aircraft skin panel is substantive. However, if the fault code or gripe associated with a maintenance activity relates to a particular LRU, then removing and replacing the aircraft skin panel is non-substantive. In this illustrative example, the context information can indicate that for a first set of fault codes and/or gripes, removal and replacement of the aircraft skin panel is substantive and for a second set of fault codes and/or gripes, the removal and replacement of the aircraft skin panel is non-substantive.

Since many different substantive procedures may be performed to correct a particular fault, the task type label or another label may be used to further identify a procedure as “corrective” or “non-corrective”. As used herein, a procedure is “corrective” if the procedure results in correction of a fault. Thus, all corrective procedures are substantive procedures, but not all substantive procedures are corrective procedures (since some substantive tasks may be performed that turn out not to clear the fault). For example, a fault isolation procedure associated with a fault in a particular LRU may indicate that the LRU should be reset and function tested, and if the fault is not cleared the LRU should be replaced. In this example, the maintenance log data 108 may include an entry 110 describing resetting the LRU, and the same entry 110 or another entry 110 may describe replacing the LRU. In this situation, the heuristic rules 138 can label a task identifier 116 associated with replacing the LRU as corrective and a task identifier 116 associated with resetting the LRU as non-corrective. In a particular implementation, the heuristic rules 138 assign corrective or non-corrective task type labels 118 based on an order or timing in which tasks were performed, an order of tasks listed in a fault isolation manual, results of a function check after an action, or other factors. To illustrate, if an entry 110 describes performance of three distinct tasks, and passing a function check after the third task, the third task may be considered corrective and the first and second task may be considered non-corrective.

After the supplemental log data 114 is generated, the search engine 142 can be used to search the maintenance log data 108, the supplemental log data 114, and perhaps other information, such as technical manuals 122, to generate recommendations or other information to facilitate aircraft maintenance. For example, a maintenance technician or other party can use the search engine to search for information regarding a particular fault code, gripe, aircraft, aircraft type, etc. In response to a search query, the search engine 142 can search the maintenance log data 108, the supplemental log data 114, and the technical manuals 122 to generate search results 158 including a list of potential corrective tasks.

By basing the search results 158 on the maintenance log data 108, the supplemental log data 114, and the technical manuals 122, the list of potential corrective tasks provided can have significant advantages over the suggested tasks or procedures in a typical fault isolation manual. For example, the corrective tasks of the list of potential corrective tasks can be based on actual historical results of various actions in particular contexts. To illustrate, each corrective task of the search results 158 corresponds to a substantive task (as defined above) that, based on the aircraft maintenance log data 108, resolved a logged complaint. That is, each corrective task of the search results 158 is associated with a task type label 118 indicating that the corresponding task identifier 116 was substantive and corrective in one or more entries 110 of the maintenance log data 108.

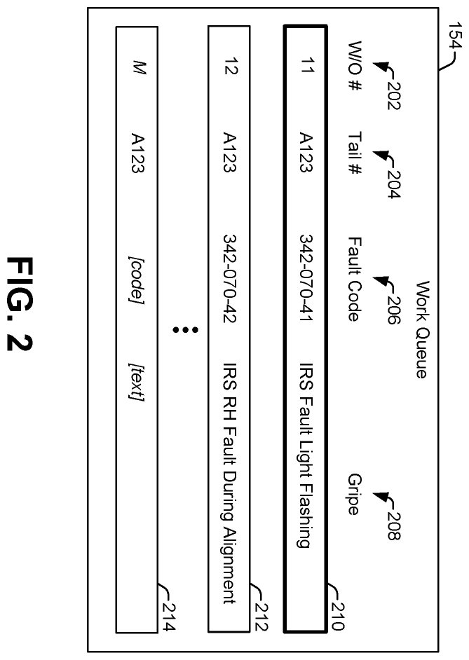

In some implementations, the search engine 142 includes, is included within, or communicates with other maintenance applications used to facilitate or manage aircraft maintenance. To illustrate, in FIG. 1, a display device 150 coupled to the computing device 130 is configured to output a variety of maintenance technician graphical interfaces, such as a work queue 154, technical manual views 156, the search results 158, and maintenance log views 160. Examples of these user interfaces are illustrated and described with reference to FIGS. 2-4.

FIG. 2 illustrates a particular example of a maintenance technician graphical interface including the work queue 154. The work queue 154 lists a set of work orders assigned to a particular maintenance technician, assigned to particular maintenance group, associated with a particular aircraft 102, or associated with a set of aircraft 102 (such as a fleet that is being maintained).

In the particular example illustrated in FIG. 2, each work order of the work queue 154 is shown in a particular row (e.g., a first row 210, a second row 212, and a third row 214), and each row 210-214 includes a plurality of data fields. For example, in FIG. 2, each row 210-214 includes a work order number (“W/O #”) 202, a tail number (or other aircraft identifier) 204, a fault code 206, and a gripe 208. To illustrate, the first row includes data associated with a work order number “11”, which is associated with an aircraft 102 identified by a tail number “A123”. The work order is to address a reported fault code “342-070-41”, which is associated with the gripe “IRS Fault Light Flashing” as a text descriptor.

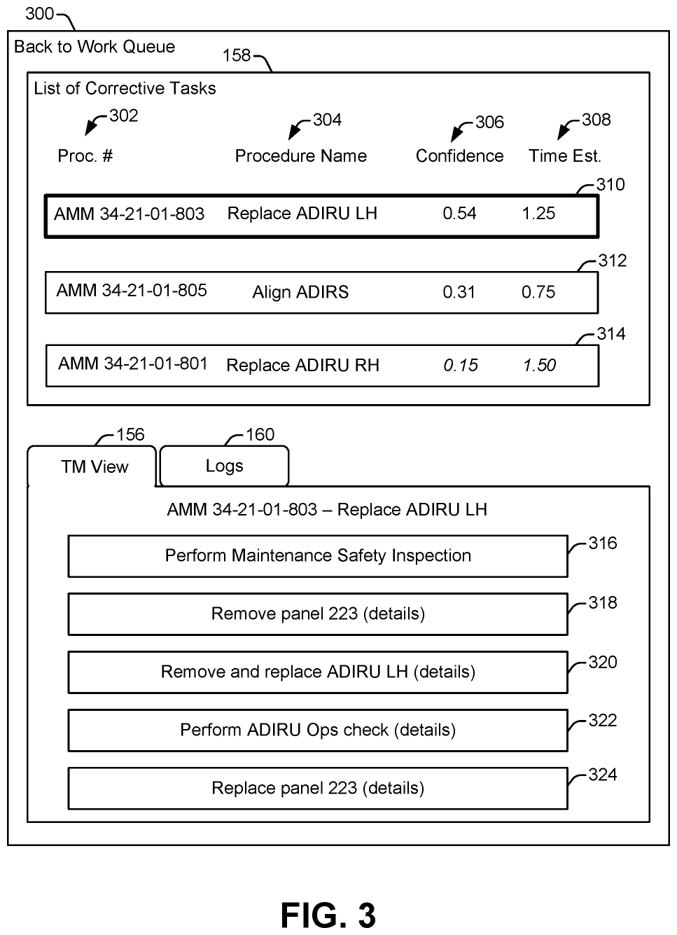

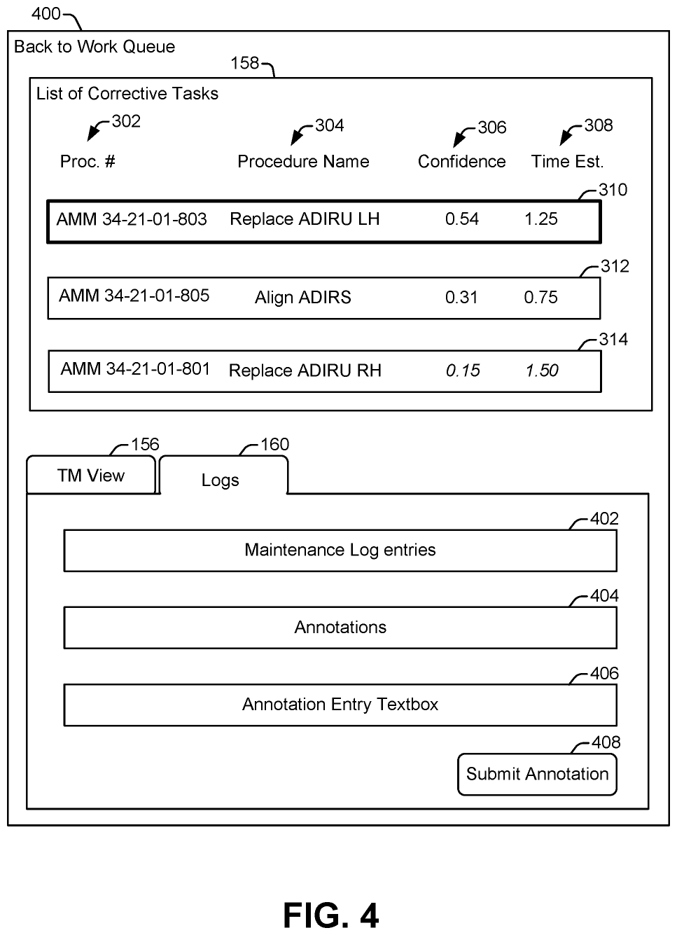

In other implementations, the work queue 154 can be arranged in a different manner or can include more or fewer fields. The specific fields and arrangement illustrated in FIG. 2 are shown to highlight interaction of the work queue 154 with the search engine 142. For example, selecting (e.g., doubling clicking) on the first row 210 can generate a search query that is provided to the search engine 142. The search query can include data from the data fields associated with the first row 210, other data, or both. FIGS. 3 and 4 illustrate examples of search results displays and other information that are displayed responsive to the search query.

FIG. 3 illustrates a particular example of a maintenance technician graphical interface 300 including the search results 158 (including the list of corrective tasks). The maintenance technician graphical interface 300 of FIG. 3 further includes a technical manual (“TM”) view 156 showing technical information associated with a particular corrective task of the list of corrective tasks.

In the particular example illustrated in FIG. 3, each corrective task of the list of corrective tasks in the search results 158 is shown in a particular row (e.g., a first row 310, a second row 312, and a third row 314), and each row 310-314 includes a plurality of data fields. For example, in FIG. 3, each row 310-314 includes a procedure number (“Proc. #”) 302, a text descriptor of the task (e.g., Procedure Name) 304, a confidence value 306, and a time estimate 308. To illustrate, the first row includes data associated with a work order number “11”, which is associated with an aircraft 102 identified by a tail number “A123”. The work order is to address a reported fault code “342-070-41”, which is associated with the gripe “IRS Fault Light Flashing” as a text descriptor.

The confidence value 306 is an indication of an estimate of how likely each task is to correct a fault identified in the search query. The confidence value 306 can be estimated based on a count or frequency with which each task is identified as corrective in the supplemental log data 114. In some implementations, the confidence value 306 is further based on the specific context in which the fault occurred in the search query, such as the count or frequency with which each task is identified as corrective in the supplemental log data 114 for the specific fault code, the specific gripe, the specific tail number, or a combination thereof

In FIG. 3, the rows 310-314 are ordered based on the confidence value associated with each task. For example, the first row 310 is associated with the highest confidence value, and the third row 314 is associated with the lowest confidence value. In some implementations, the rows 310-314 can be re-sorted or rearranged based on user input or user preferences. For example, the rows 310-314 can be re-sorted based on the time estimate associated with each row.

The technical manual view 156 shows details of a selected procedure or task of the search results 158. For example, in FIG. 3, the first row 310 is highlighted, indicating that a user has selected the first row 310 corresponding to procedure number “AMM 34-21-01-803” which has procedure name “Replace ADIRU LH”. Based on selection of the first row 310, the technical manual view 156 lists the specific steps or task associated with the selected procedure. In the example illustrated in FIG. 3, the selected procedure includes several tasks (tasks 316-324), including both substantive and non-substantive tasks. For example, in FIG. 3, a first task 316 of the procedure includes performing a maintenance safety inspection to prepare the aircraft for safe maintenance. Accordingly, the first task 316 is non-substantive. Further, in FIG. 3, a third task 320 includes removing and replacing a left hand (LH) air data inertial reference unit (ADIRU), which is a substantive task to correct an ADIRU related fault.

FIG. 4 illustrates a particular example of a maintenance technician graphical interface 400 including the search results 158 (including the list of corrective tasks) and an annotated maintenance log view 160 showing one or more maintenance log entries 402 associated with a particular corrective task of the list of corrective tasks. The search results 158 displayed in the maintenance technician graphical interface 400 of FIG. 4 are identical to the search results of the maintenance technician graphical interface 300 of FIG. 3.

In the example illustrated in FIG. 4, the annotated maintenance log view 160 includes or lists one or more maintenance log entries 420 associated with a selected search result, e.g., the highlighted first row 310. The maintenance log entries 420 are a subset of the maintenance entries 110, where the subset includes those entries 110 associated with the same aircraft tail number as the selected search result, the same complaint (e.g., the same fault code or the same gripe) as the selected search result, the same task identifier as the selected search result, or a combination thereof.

In some implementations, one or more of the maintenance log entries 420 is associated with one or more annotations 404. The annotations 404 are generally notes provided by other maintenance technicians regarding the corresponding maintenance log entry 402. For example, some procedure descriptions within the technical manuals 122 may have ambiguous or unclear descriptions for some steps. In this example, a maintenance technician can annotate a maintenance log entry related to the procedure description to provide suggestions for clarifying the procedure description for other maintenance technicians. As another example, a maintenance technician may recommend performing particular steps (e.g., troubleshooting steps) is a particular order or using a particular tool. Such annotations can be a valuable source of insights for other maintenance technicians; however, the official record of the maintenance logs 104 and maintenance log data 108 is not the appropriate location for such annotations. Accordingly, the annotations can be stored as a portion of the supplemental log data 114.

In FIG. 4, the annotated maintenance log view 160 also includes one or more selectable controls to generate an annotation to a maintenance log entry 420. For example, the selectable controls include an annotation entry textbox 406 in which a user can enter text of an annotation. The selectable controls of FIG. 4 also include a submit annotation button 408 to submit an annotation entered in the annotation entry textbox 406. In other implementations, the annotated maintenance log view 160 can include other selectable controls to input, edit, or search annotations in the supplemental log data 114.

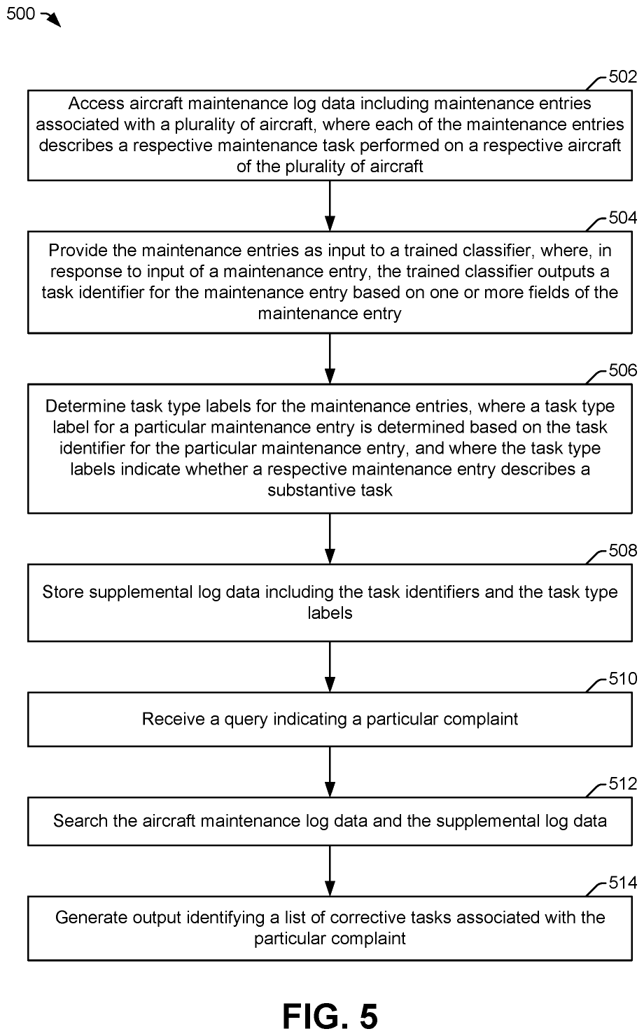

FIG. 5 illustrates a flow chart of a particular example of a method 500 of generating supplement aircraft maintenance log data and generating an ordered list of corrected tasks based on a search query. The method 500 can be performed by the computing device(s) 130 of FIG. 1 or another device executing the instructions described with reference to FIG. 1.

The method 500 includes, at 502, accessing aircraft maintenance log data including maintenance entries associated with a plurality of aircraft, where each of the maintenance entries describes a respective maintenance task performed on a respective aircraft of the plurality of aircraft. For example, the computing device(s) 130 (or one or more processors 132 of the computing device(s) 130) can access the maintenance log data 108 from the database 106 or another storage location.

The method 500 also includes, at 504, providing the maintenance entries 110 as input to the trained classifier 136. In response to input of a maintenance entry 110, the trained classifier 136 outputs a task identifier 116 for the maintenance entry 110 based on one or more fields 112 of the maintenance entry 110.

The method 500 further includes, at 506, determining task type labels for the maintenance entries. For example, the computing device(s) 130 can execute the heuristic rules 138 to evaluate each of the task identifiers 116 assigned by the trained classifier 136 to determine a task type label 118 for each of the maintenance entries 110. To illustrate, in response to execution of one or more of the heuristic rules 138, the processor(s) compare the task identifier 116 of the particular maintenance entry 110 to the list of repair actions 140 to determine whether the task identifier 116 corresponds to a repair action. In this illustrative example, each repair action identified in the list of repair actions 140 is intended to repair a complaint, and the list of repair actions 140 omits procedural actions associated with the repair actions.

In some implementations, the processor(s) 132 executing the heuristic rule 138 assign the task type labels 118 based on context information, such as one or more fields 112 of each entry, in addition to or instead of based on the task identifier 116 of each entry 110. The task type labels 118 indicate whether a respective maintenance entry 110 describes a substantive task. In some implementation, the task type labels 118 also indicate whether each substantive task is a corrective task. For example, the heuristic rules 138 are executable to determine, from among the maintenance entries 110, a set of corrective tasks, where each corrective task of the set of corrective tasks corresponds to a substantive task that, based on the aircraft maintenance log data 108, resolved a logged complaint. In some implementations, the heuristic rules 138 are executable to determine whether a particular task resolved a respective logged complaint based on an order of the particular substantive task relative to other logged tasks, a timing of the particular substantive task relative to the other logged tasks, a logged result of a function check, or a combination thereof.

The method 500 also includes, at 508, storing supplemental log data including the task identifiers and the task type labels. For example, the computing device(s) may store the supplemental log data 114 in the database 106, or in another data structure.

In the example illustrated in FIG. 5, the method 500 also includes, at 510, receiving a query indicating a particular complaint (e.g., fault code, a gripe, or both) associated with an aircraft. The method 500 also includes, at 512, searching the aircraft maintenance log data 108 and the supplemental log data 114 in response to the query. For example, the search engine 142 can search the aircraft maintenance log data 108 and the supplemental log data 114 based on the particular complaint, an aircraft type, an aircraft tail number, other information in the query, or a combination thereof. In some implementations, the search engine 142 also searches the technical manuals 122, annotations associated with the aircraft maintenance log data 108, or annotations associated with the technical manuals 122 in response to the query. In a particular implementation, the search query is automatically generated and executed in response to a user selecting an item in the work queue 154.

The method 500 also includes, at 514, generating output including search results from the search engine. For example, in the example illustrated in FIG. 5, the search results identify a list of corrective tasks associated with the particular complaint. In some implementations, the search results or a portion thereof, such as the list of corrective tasks, is ordered based on a number of times each corrective task resolved the particular complaint based on the aircraft maintenance log data 108.

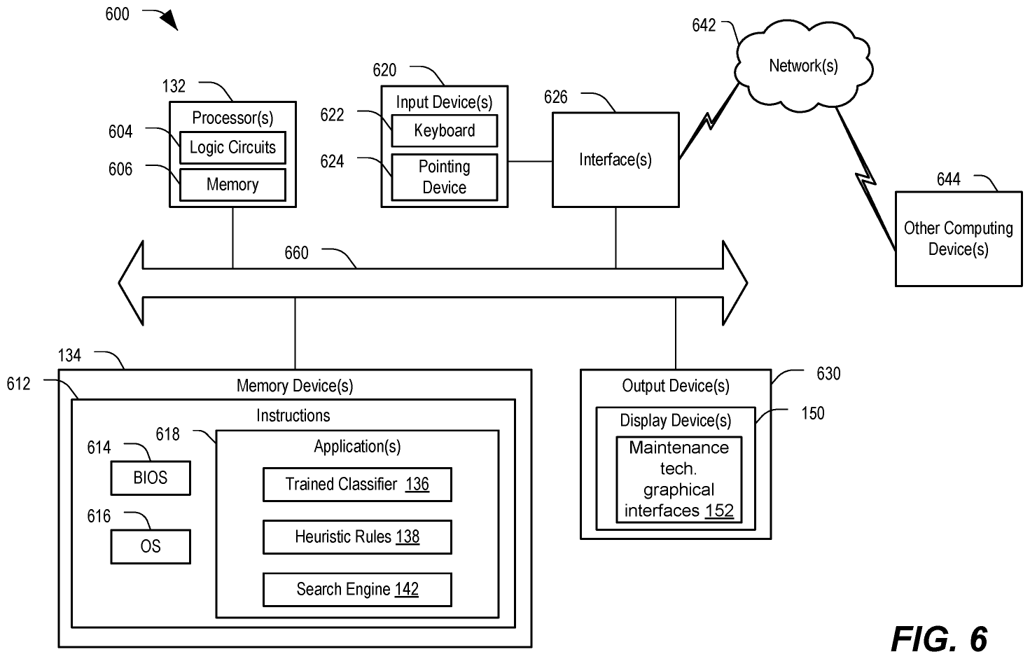

FIG. 6 is a block diagram of a particular computer system 600 configured to initiate, perform, or control one or more of the operations described with reference to FIGS. 1-5. For example, the computer system 600 may include, or be included within, the computing device(s) 130 of FIG. 1. The computer system 600 can be implemented as or incorporated into one or more of various other devices, such as a personal computer (PC), a tablet PC, a server computer, a personal digital assistant (PDA), a laptop computer, a desktop computer, a communications device, a wireless telephone, or any other machine capable of executing a set of instructions (sequential or otherwise) that specify actions to be taken by that machine. Further, while a single computer system 600 is illustrated, the term “system” includes any collection of systems or sub-systems that individually or jointly execute a set, or multiple sets, of instructions to perform one or more computer functions.

While FIG. 6 illustrates one example of the particular computer system 600, other computer systems or computing architectures and configurations may be used for operations disclosed herein. The computer system 600 includes the one or more processors 132. Each processor of the one or more processors 132 can include a single processing core or multiple processing cores that operate sequentially, in parallel, or sequentially at times and in parallel at other times. Each processor of the one or more processors 132 includes circuitry defining a plurality of logic circuits 604, working memory 606 (e.g., registers and cache memory), communication circuits, etc., which together enable the processor to control the operations performed by the computer system 600 and enable the processor to generate a useful result based on analysis of particular data and execution of specific instructions.

The processor(s) 132 are configured to interact with other components or subsystems of the computer system 600 via a bus 660. The bus 660 is illustrative of any interconnection scheme serving to link the subsystems of the computer system 600, external subsystems or device, or any combination thereof. The bus 660 includes a plurality of conductors to facilitate communication of electrical and/or electromagnetic signals between the components or subsystems of the computer system 600. Additionally, the bus 660 includes one or more bus controller or other circuits (e.g., transmitters and receivers) that manage signaling via the plurality of conductors and that cause signals sent the plurality of conductors to conform to particular communication protocols.

The computer system 600 also includes the one or more memory devices 134. The memory devices 134 include any suitable computer-readable storage device depending on, for example, whether data access needs to be bi-directional or unidirectional, speed of data access required, memory capacity required, other factors related to data access, or any combination thereof. Generally, the memory devices 134 includes some combinations of volatile memory devices and non-volatile memory devices, though in some implementations, only one or the other may be present. Examples of volatile memory devices and circuits include registers, caches, latches, many types of random-access memory (RAM), such as dynamic random-access memory (DRAM), etc. Examples of non-volatile memory devices and circuits include hard disks, optical disks, flash memory, and certain type of RAM, such as resistive random-access memory (ReRAM). Other examples of both volatile and non-volatile memory devices can be used as well, or in the alternative, so long as such memory devices store information in a physical, tangible medium. Thus, the memory devices 134 include circuit and structures and are not merely signals or other transitory phenomena.

The memory device(s) 134 store the instructions 612 that are executable by the processor(s) 132 to perform various operations and functions. The instructions 612 include instructions to enable the various components and subsystems of the computer system 600 to operate, interact with one another, and interact with a user, such as an input/output system (BIOS) 614 and an operating system (OS) 616. Additionally, the instructions 612 include one or more applications 618, scripts, or other program code to enable the processor(s) 132 to perform the operations described herein. For example, the instructions 612 can include the trained classifier 136, the heuristic rules 138, and the search engine 142, as described with reference to FIGS. 1-5.

In FIG. 6, the computer system 600 also includes one or more output devices 630, one or more input devices 620, and one or more interface devices 626. Each of the output device(s) 630, the input device(s) 620, and the interface device(s) 626 can be coupled to the bus 660 via an a port or connector, such as a Universal Serial Bus port, a digital visual interface (DVI) port, a serial ATA (SATA) port, a small computer system interface (SCSI) port, a high-definition media interface (HMDI) port, or another serial or parallel port. In some implementations, one or more of the output device(s) 630, the input device(s) 620, the interface device(s) 626 is coupled to or integrated within a housing with the processor(s) 132 and the memory devices 134, in which case the connections to the bus 660 can be internal, such as via an expansion slot or other card-to-card connector. In other implementations, the processor(s) 132 and the memory devices 134 are integrated within a housing that includes one or more external ports, and one or more of the output device(s) 630, the input device(s) 620, the interface device(s) 626 is coupled to the bus 660 via the external port(s).

Examples of the output device(s) 630 include the display device(s) 150, speakers, printers, televisions, projectors, or other devices to provide output of data in a manner that is perceptible by a user, such as via the maintenance technician graphical interfaces 152. Examples of the input device(s) 620 include buttons, switches, knobs, a keyboard 622, a pointing device 624, a biometric device, a microphone, a motion sensor, or another device to detect user input actions. The pointing device 624 includes, for example, one or more of a mouse, a stylus, a track ball, a pen, a touch pad, a touch screen, a tablet, another device that is useful for interacting with a graphical user interface, or any combination thereof.

The interface device(s) 626 is configured to enable the computer system 600 to communicate with one or more other computer system 644 via one or more networks 642. The interface device(s) 626 encode data in electrical and/or electromagnetic signals that are transmitted to the other computer system(s) 644 using pre-defined communication protocols. The electrical and/or electromagnetic signals can be transmitted wirelessly (e.g., via propagation through free space), via one or more wires, cables, optical fibers, or via a combination of wired and wireless transmission.

In an alternative embodiment, dedicated hardware implementations, such as application specific integrated circuits, programmable logic arrays and other hardware devices, can be constructed to implement one or more of the operations described herein. Accordingly, the present disclosure encompasses software, firmware, and hardware implementations.

It is to be understood that the division and ordering of steps described herein is for illustrative purposes only and is not be considered limiting. In alternative implementations, certain steps may be combined and other steps may be subdivided into multiple steps. Moreover, the ordering of steps may change.

The systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of techniques for data transmission, signaling, data processing, network control, and the like.

The systems and methods of the present disclosure may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based (e.g., cloud computing) embodiment, an entirely hardware embodiment, or an embodiment combining aspects of the internet, software and hardware. Furthermore, the system may take the form of a computer program product on a computer-readable storage medium or device having computer-readable program code (e.g., instructions) embodied or stored in the storage medium or device. Any suitable computer-readable storage medium or device may be utilized, including hard disks, CD-ROM, optical storage devices, magnetic storage devices, and/or other storage media. As used herein, a “computer-readable storage medium” or “computer-readable storage device” is not a signal.

Computer program instructions may be loaded onto a computer or other programmable data processing apparatus to produce a machine, such that the instructions that execute on the computer or other programmable data processing apparatus create means for implementing operations or functions specified in flowchart block or blocks. These computer program instructions may also be stored in a computer-readable memory or device that can direct a computer or other programmable data processing apparatus to function in a particular manner, such that the instructions stored in the computer-readable memory produce an article of manufacture including instruction means which implement the operation or function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the operations or functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Although the disclosure may include a method, it is contemplated that it may be embodied as computer program instructions on a tangible computer-readable medium, such as a magnetic or optical memory or a magnetic or optical disk/disc. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

Changes and modifications may be made to the disclosed embodiments without departing from the scope of the present disclosure. These and other changes or modifications are intended to be included within the scope of the present disclosure, as expressed in the following claims.

1. A method comprising:
accessing, by one or more processors of a computing device, aircraft maintenance log data including maintenance entries associated with maintenance of a plurality of aircraft, wherein each of the maintenance entries for maintenance work on an aircraft of the plurality of aircraft describes a respective maintenance task of two or more maintenance tasks of the maintenance work performed on the aircraft;
providing, by the one or more processors, the maintenance entries as input to a trained classifier, wherein, in response to input of a maintenance entry of particular maintenance work for a particular aircraft, the trained classifier outputs a task identifier for the maintenance entry based on one or more fields of the maintenance entry;
determining, by the one or more processors based on the task identifier output by the trained classifier for the maintenance entry, a task type indicating whether the maintenance entry for the maintenance task of the particular maintenance work describes a substantive task; and
generating and storing, by the one or more processors, supplemental log data including the task identifier and the task type.

2. The method of claim 1, further comprising determining, by the one or more processors, a set of corrective tasks, wherein each corrective task of the set of corrective tasks corresponds to a substantive task that, based on the aircraft maintenance log data, resolved a logged complaint, wherein the supplemental log data further includes a corrective label associated with each corrective task of the set of corrective tasks.

3. The method of claim 2, wherein a particular substantive task is determined to have resolved a respective logged complaint based on an order of the particular substantive task relative to other logged tasks, a timing of the particular substantive task relative to the other logged tasks, a logged result of a function check, or a combination thereof.

4. The method of claim 2, further comprising, in response to a query indicating a particular complaint:
searching the aircraft maintenance log data and the supplemental log data; and
generating output identifying a list of corrective tasks associated with the particular complaint.

5. The method of claim 4, further comprising sorting the list of corrective tasks in the output based on a number of times each corrective task resolved the particular complaint based on the aircraft maintenance log data.

6. The method of claim 1, wherein particular maintenance work for the maintenance of a particular aircraft comprises fault isolation, and wherein particular maintenance tasks of particular maintenance entries for the fault isolation comprise removal of an aircraft skin panel, replacement of a line-replaceable unit, and reattach the aircraft skin panel.

7. The method of claim 1, wherein determining the task type for the maintenance entry comprises comparing the task identifier of the maintenance entry to a list of repair actions, wherein each repair action is intended to repair a complaint and wherein the list of repair actions omits procedural actions associated with the repair actions.

8. A system comprising:
one or more processors; and
one or more memory devices storing instructions executable by the one or more processors to perform operations comprising:
accessing aircraft maintenance log data including maintenance entries associated with maintenance of a plurality of aircraft, wherein each of the maintenance entries for maintenance work on an aircraft of the plurality of aircraft describes a respective maintenance task of two or more maintenance tasks of the maintenance work performed on the aircraft;
providing the maintenance entries as input to a trained classifier, wherein, in response to input of a maintenance entry of particular maintenance work for a particular aircraft, the trained classifier outputs a task identifier for the maintenance entry based on one or more fields of the maintenance entry;
determining, based on the task identifier output by the trained classifier for the maintenance entry, a task type label indicating whether the maintenance entry for the maintenance task of the particular maintenance work describes a substantive task; and
generating and storing, in the one or more memory devices, supplemental log data including the task identifier and the task type label.

9. The system of claim 8, wherein the operations further comprise determining a set of corrective tasks, wherein each corrective task of the set of corrective tasks corresponds to a substantive task that, based on the aircraft maintenance log data, resolved a logged complaint, wherein the supplemental log data further includes a corrective label associated with each corrective task of the set of corrective tasks.

10. The system of claim 9, wherein a particular substantive task is determined to have resolved a respective logged complaint based on an order of the particular substantive task relative to other logged tasks, a timing of the particular substantive task relative to the other logged tasks, a logged result of a function check, or a combination thereof.

11. The system of claim 9, wherein the operations further comprise, in response to a query indicating a particular complaint:
searching the aircraft maintenance log data and the supplemental log data; and
generating output identifying a list of corrective tasks associated with the particular complaint.

12. The system of claim 11, wherein the operations further comprise sorting the list of corrective tasks in the output based on a number of times each corrective task resolved the particular complaint based on the aircraft maintenance log data.

13. The system of claim 11, wherein the aircraft maintenance log data and the supplemental log data are searched based on the particular complaint, an aircraft type, an aircraft tail number, or a combination thereof.

14. The system of claim 8, wherein determining the task type label for the maintenance entry comprises comparing the task identifier of the maintenance entry to a list of repair actions, wherein each repair action is intended to repair a complaint and wherein the list of repair actions omits procedural actions associated with the repair actions.

15. A computer-readable storage device storing instructions executable by one or more processors to cause the one or more processors to perform operations comprising:
accessing aircraft maintenance log data including maintenance entries associated with maintenance of a plurality of aircraft, wherein each of the maintenance entries for maintenance work on an aircraft of the plurality of aircraft describes a respective maintenance task of two or more maintenance tasks of the maintenance work performed on the aircraft;
providing the maintenance entries as input to a trained classifier, wherein, in response to input of a maintenance entry of particular maintenance work for a particular aircraft, the trained classifier outputs a task identifier for the maintenance entry based on one or more fields of the maintenance entry;
determining, based on a task identifier output by the trained classifier for the maintenance entry, a task type label indicating whether the maintenance entry for the maintenance task of the particular maintenance work describes a substantive task; and
generating and storing, in one or more memory devices, supplemental log data including the task identifier and the task type label.

16. The computer-readable storage device of claim 15, wherein the operations further comprise determining a set of corrective tasks, wherein each corrective task of the set of corrective tasks corresponds to a substantive task that, based on the aircraft maintenance log data, resolved a logged complaint, wherein the supplemental log data further includes a corrective label associated with each corrective task of the set of corrective tasks.

17. The computer-readable storage device of claim 16, wherein a particular substantive task is determined to have resolved a respective logged complaint based on an order of the particular substantive task relative to other logged tasks, a timing of the particular substantive task relative to the other logged tasks, a logged result of a function check, or a combination thereof.

18. The computer-readable storage device of claim 16, wherein the operations further comprise, in response to a query indicating a particular complaint:
searching the aircraft maintenance log data and the supplemental log data; and
generating output identifying a list of corrective tasks associated with the particular complaint.

19. The computer-readable storage device of claim 18, wherein the operations further comprise sorting the list of corrective tasks in the output based on a number of times each corrective task resolved the particular complaint based on the aircraft maintenance log data.

20. The computer-readable storage device of claim 18, wherein the aircraft maintenance log data and the supplemental log data are searched based on the particular complaint, an aircraft type, an aircraft tail number, or a combination thereof.

21. The computer-readable storage device of claim 15, wherein determining the task type label for the maintenance entry comprises comparing the task identifier of the maintenance entry to a list of repair actions, wherein each repair action is intended to repair a complaint and wherein the list of repair actions omits procedural actions associated with the repair actions.
